(19) United States
(12) Patent Application Publication
(10) Pub. No.: US 2020/0255317 A1
(43) Pub. Date: Aug. 13, 2020

(54) METHODS FOR PRODUCTING THERMALLY STRENGTHENED GLASS WITH ENHANCED STRENGTH PROPERTIES

(71) Applicant: CORNING INCORPORATED, CORNING, NY (US)

(72) Inventor: Ravindra Kumar Akarapu, Horseheads, NY (US)

(21) Appl. No.: 16/639,295

(22) PCT Filed: Aug. 17, 2018
(86) PCT No.: PCT/US2018/000276

§ 371 Date: Feb. 14, 2020

Related U.S. Application Data
(60) Provisional application No. 62/546,843, filed on Aug. 17, 2017.

(51) Int. Cl. C03B 27/048; C03B 25/093; C03B 35/24

(52) U.S. Cl. CPC C03B 27/048; C03B 35/24; C03B 25/093

(57) ABSTRACT

Thermally treating a glass sheet by holding the glass sheet between first and second gas bearings, the glass sheet having first and second major surfaces on opposite sides thereof and an edge surface surrounding the sheet and connecting the first and second major surfaces, the glass sheet being held with the first major surface adjacent to the first gas bearing and the second major surface adjacent to the second gas bearing, a glass of the glass sheet having a glass softening temperature, and, while holding the glass sheet between the first and second gas bearings, maintaining the glass sheet at a viscosity η(t) for a time t such that the value of the expression (30 MPa times the integral from 0 to t of t/η(t) with respect to t) is within the range of from 10 to 10⁶.

### CROSS-REFERENCE TO RELATED APPLICATIONS

This application claims the benefit of priority under 35 U.S.C. § 119 of U.S. Provisional Application No. 62/546,843, filed Aug. 17, 2017, the content of which is incorporated herein by reference in its entirety.

### FIELD

The present disclosure relates methods for producing thermally strengthened glass having improved strength properties.

### BACKGROUND

It is known to heat glass sheets and maintain the sheets at elevated temperatures for extended periods to reduce the effects of undesired stresses and of flaws in the glass sheets. It is also known to thermally strengthen a glass sheet by quenching (cooling quickly) a glass sheet from an initial elevated temperature T₀ above a glass transition temperature of a glass of the sheet, to a temperature below the glass transition temperature. To maintain sheet flatness, sheet smoothness (i.e., low nano- or micro-scale roughness) and optical and other desired sheet properties during thermal strengthening, a time which the sheet spends at or above T₀ is generally minimized as much as possible.

### SUMMARY

The following presents a simplified summary of the disclosure in order to provide a basic understanding of some exemplary embodiments described in the detailed description.

In embodiments, a method of thermally treating a glass sheet comprises holding a glass sheet between first and second gas bearings, the glass sheet having first and second major surfaces on opposite sides thereof and an edge surface surrounding the sheet and connecting the first and second major surfaces, the glass sheet being held with the first major surface adjacent to the first gas bearing and the second major surface adjacent to the second gas bearing, a glass of the glass sheet having a glass transition temperature, and, while holding the glass sheet between the first and second gas bearings, maintaining the glass sheet at a temperature T, where T is a temperature in the range of from 50° to 250° C. above the glass transition temperature, for a time t within the range of 5 to 1000 seconds. T may also be a temperature in the range of from 75° to 250° C. above the glass transition temperature, 100° to 250° C. above the glass transition temperature, 125° to 250° C. above the glass transition temperature, 150° to 250° C. above the glass transition temperature, 175° to 250° C. above the glass transition temperature, 200° to 250° C. above the glass transition temperature, or even 225° to 250° C. above the glass transition temperature. The time t may also be within the range of from 10 to 1000 seconds, 15 to 1000 seconds, 20 to 1000 seconds, 30 to 1000 seconds, 40 to 1000 seconds, 50 to 1000 seconds, 60 to 1000 seconds, 75 to 1000 seconds, 100 to 1000 seconds, 125 to 1000 seconds, 150 to 1000 seconds, 175 to 1000 seconds, or even 200 (or more) to 1000 seconds.

In embodiments, a method of thermally treating a glass sheet comprises holding a glass sheet between first and second gas bearings, the glass sheet having first and second major surfaces on opposite sides thereof and an edge surface surrounding the sheet and connecting the first and second major surfaces, the glass sheet being held with the first major surface adjacent to the first gas bearing and the second major surface adjacent to the second gas bearing, a glass of the glass sheet having a glass softening temperature, and, while holding the glass sheet between the first and second gas bearings, maintaining the glass sheet at a temperature T, where T is a temperature within the range of 100° C. below to 50° C. above the glass softening temperature, for a time t within the range of 5 to 1000 seconds. T may also be within the range of from 90° C. below to 50° C. above the glass softening temperature, from 80° C. below to 50° C. above the glass softening temperature, from 70° C. below to 50° C. above the glass softening temperature , from 60° C. below to 50° C. above the glass softening temperature, from 50° C. below to 50° C. above the glass softening temperature, from 40° C. below to 50° C. above the glass softening temperature, from 30° C. below to 50° C. above the glass softening temperature, from 20° C. below to 50° C. above the glass softening temperature, from 10° C. below to 50° C. above the glass softening temperature, from the glass softening temperature to 50° C. above the glass softening temperature, from 10° C. above to 50° C. above the glass softening temperature, from 20° C. above to 50° C. above the glass softening temperature, from 30° C. above to 50° C. above the glass softening temperature, or even from 40° C. above to 50° C. above the glass softening temperature. The time t may also be within the range of from 10 to 1000 seconds, 15 to 1000 seconds, 20 to 1000 seconds, 30 to 1000 seconds, 40 to 1000 seconds, 50 to 1000 seconds, 60 to 1000 seconds, 75 to 1000 seconds, 100 to 1000 seconds, 125 to 1000 seconds, 150 to 1000 seconds, 175 to 1000 seconds, or even 200 (or more) to 1000 seconds.

In embodiments, a method of thermally treating a glass sheet comprises holding a glass sheet between first and second gas bearings, the glass sheet having first and second major surfaces on opposite sides thereof and an edge surface surrounding the sheet and connecting the first and second major surfaces, the glass sheet being held with the first major surface adjacent to the first gas bearing and the second major surface adjacent to the second gas bearing, a glass of the glass sheet having a glass softening temperature, and, while holding the glass sheet between the first and second gas bearings, maintaining the glass sheet at a viscosity η for a time t such that the value of the expression (t·30 MPa/η) is within the range of from 10 to 10⁶. This expression may also be within the range of from 15 to 10⁶, from 20 to 10⁶, 30 to 10⁶, 50 to 10⁶, 10² to 10⁶, 10³ to 10⁶, 10³ to 10⁶, 10⁴ to 10⁶, or even 10⁵ to 10⁶.

In embodiments, a method of thermally treating a glass sheet comprises holding a glass sheet between first and second gas bearings, the glass sheet having first and second major surfaces on opposite sides thereof and an edge surface surrounding the sheet and connecting the first and second major surfaces, the glass sheet being held with the first major surface adjacent to the first gas bearing and the second major surface adjacent to the second gas bearing, a glass of the glass sheet having a glass softening point temperature, and, while holding the glass sheet between the first and second gas bearings, maintaining the glass sheet at a viscosity (t) for a time t such that the value of the expression

$$30 MPa \cdot {\int }_{0}^{t} \frac{t}{η ( t )} dt$$

is within the range of from 10 to 10⁶. This expression may also be within the range of from 15 to 10⁶, from 20 to 10⁶, 30 to 10⁶, 50 to 10⁶, 10² to 10⁶, 10³ to 10⁶, 10³ to 10⁶, 10⁴ to 10⁶, or even 10⁵ to 10⁶.

In embodiments according to any of the above embodiments, the method further comprises, after the step of maintaining, cooling the sheet to ambient temperature over a time period in the range of from 1 minute to 10 hours. This step of cooling may be performed while holding the glass sheet between the first and second gas bearings or while holding the glass sheet between third and fourth gas bearings. Alternatively in embodiments according to any of the above embodiments, the method according further comprises, after the step of maintaining, cooling the sheet using an effective heat transfer coefficient in the range from 300 W/m²K to 15000 W/m²K. The effective heat transfer coefficient may also be within the range of from 400 W/m²K to 15000 W/m²K, 500 W/m²K to 15000 W/m²K, 600 W/m²K to 15000 W/m²K, 700 W/m²K to 15000 W/m²K, 800 W/m²K to 15000 W/m²K, 900 W/m²K to 15000 W/m²K, 1000 W/m²K to 15000 W/m²K, 1250 W/m²K to 15000 W/m²K, 1500 W/m²K to 15000 W/m²K, 1750 W/m²K to 15000 W/m²K, 2000 W/m²K to 15000 W/m²K, 2250 W/m²K to 15000 W/m²K, 2500 W/m²K to 15000 W/m²K, 2750 W/m²K to 15000 W/m²K, 3000 W/m²K to 15000 W/m²K, 400 W/m²K to 15000 W/m²K, 3250 W/m²K to 15000 W/m²K, 3500 W/m²K to 15000 W/m²K, or even 4000 (or more) W/m²K to 15000 W/m²K. This step of cooling may be performed while holding the glass sheet between third and fourth gas bearings.

In embodiments according to any of the above embodiments, the first and second gas bearings each respectively comprise a bearing surface having holes therein for gas passage therethrough and the holes have an average center-to-center spacing in the range of from 20 micrometers to 1 centimeter. The average center-to-center spacing may also be in the range of from 20 micrometers to 5 mm, 20 micrometers to 3 mm, 20 micrometers to 2 mm, 20 micrometers to 1 mm, 20 to 800 micrometers, 20 to 600 micrometers, 20 to 500 micrometers, 20 to 400 micrometers, 20 to 300 micrometers, 20 to 200 micrometers, or even 20 to 100 (or even less) micrometers.

In embodiments according to any of the above embodiments, the first and second gas bearings each respectively comprise a bearing surface having holes therein for gas passage therethrough and the holes have an average diameter in the range of from 5 micrometers to 1 millimeter. The average diameter may also be in the range of from 5 to 5 to 500 micrometers, 5 to 200 micrometers, 5 to 150 micrometers, 5 to 100 micrometers, 5 to 75 micrometers, 5 to 50 micrometers, 5 to 40 micrometers, 5 to 30 micrometers, 5 to 25 micrometers, 5 to 20 micrometers, 5 to 15 micrometers, or even 5 to 10 micrometers.

The above embodiments are exemplary and can be provided alone or in any combination with any one or more embodiments provided herein without departing from the scope of the disclosure. Moreover, it is to be understood that both the foregoing general description and the following detailed description present embodiments of the present disclosure, and are intended to provide an overview or framework for understanding the nature and character of the embodiments as they are described and claimed. The accompanying drawings are included to provide a further understanding of the embodiments, and are incorporated into and constitute a part of this specification. The drawings illustrate various embodiments of the disclosure, and together with the description, serve to explain the principles and operations thereof.

### BRIEF DESCRIPTION OF THE DRAWINGS

These and other features, embodiments, and advantages of the present disclosure can be further understood when read with reference to the accompanying drawings:

FIG. 1 shows a flow chart of embodiments of methods according to the present disclosure;

FIG. 2 is a schematic cross-sectional view of an embodiment of an apparatus useful in carrying out methods in accordance with embodiments of the disclosure;

FIG. 3 is a schematic cross-sectional view of an embodiment of an apparatus useful in carrying out methods in accordance with embodiments of the disclosure;

FIG. 4 is a plan view of an embodiment of a gas bearing structure useful in carrying out methods in accordancc with embodiments of the disclosure;

FIG. 5 is a graph showing a performance increase of glass sheets processed in accordance with embodiments of the disclosure;

FIG. 6 is a graph showing a performance increase of glass sheets processed in accordance with embodiments of the disclosure; and

FIG. 7 is a graph showing a performance increase of glass sheets processed in accordance with embodiments of the disclosure.

### DETAILED DESCRIPTION

Methods and apparatus will now be described more fully hereinafter with reference to the accompanying drawings in which exemplary embodiments of the disclosure are shown. Whenever possible, the same reference numerals are used throughout the drawings to refer to the same or like parts. However, this disclosure can be embodied in many different forms and should not be construed as limited to the embodiments set forth herein.

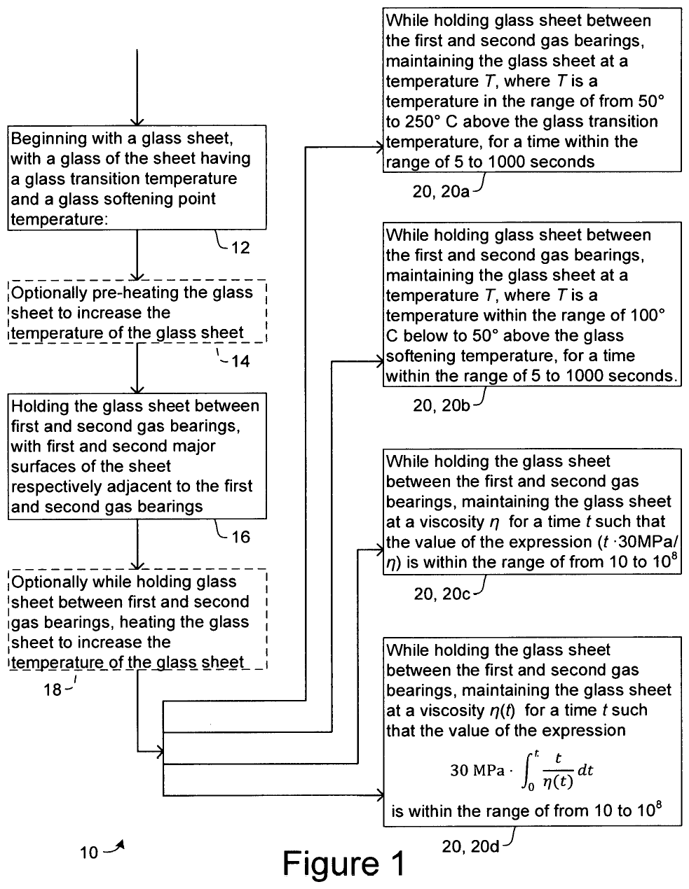

FIG. 1 shows a flow chart 10 of embodiments of methods according to the present disclosure. In accordance with the embodiments shown, the methods start in step 12 with a glass sheet comprising a glass having a glass transition temperature and a glass softening point temperature. Next, optionally as shown in optional step 14, the glass sheet is pre-heated to increase the temperature of the glass sheet. Then, as shown in step 16, the glass sheet is held between first and second gas bearings, with first and second major surfaces of the sheet respectively adjacent to the first and second gas bearings. Then, optionally as shown in optional step 18, while holding the glass sheet between first and second gas bearings, the glass sheet is heated to increase the temperature of the glass sheet. Next, as shown in step 20, as embodied in one alternative of steps 20a through 20d, the glass sheet is held at a relatively high temperature or relatively low viscosity, for a relatively long time.

Specifically, as shown in in the alternative of step 20a, while holding the glass sheet between first and second gas bearings, the glass sheet is maintained (is kept) at a temperature T, where T is a temperature in the range of from 50° to 250° C. above the glass transition temperature, for a time within the range of 5 to 1000 seconds. T may also be a temperature in the range of from 75° to 250° C. above the glass transition temperature, 100° to 250° C. above the glass transition temperature, 125° to 250° C. above the glass transition temperature, 150° to 250° C. above the glass transition temperature, 175° to 250° C. above the glass transition temperature, 200° to 250° C. above the glass transition temperature, or even 225° to 250° C. above the glass transition temperature. The time t may also be within the range of from 10 to 1000 seconds, 15 to 1000 seconds, 20 to 1000 seconds, 30 to 1000 seconds, 40 to 1000 seconds, 50 to 1000 seconds, 60 to 1000 seconds, 75 to 1000 seconds, 100 to 1000 seconds, 125 to 1000 seconds, 150 to 1000 seconds, 175 to 1000 seconds, or even 200 (or more) to 1000 seconds.

Specifically as shown in step 20b, while holding glass sheet between the first and second gas bearings, the glass sheet is maintained at a temperature T, where T is a temperature within the range of 100° C. below to 50° above the glass softening temperature, for a time within the range of 5 to 1000 seconds. T may also be within the range of from 90° C. below to 50° C. above the glass softening temperature, from 80° C. below to 50° C. above the glass softening temperature, from 70° C. below to 50° C. above the glass softening temperature, from 60° C. below to 50° C. above the glass softening temperature, from 50° C. below to 50° C. above the glass softening temperature, from 40° C. below to 50° C. above the glass softening temperature, from 30° C. below to 50° C. above the glass softening temperature, from 20° C. below to 50° C. above the glass softening temperature, from 10° C. below to 50° C. above the glass softening temperature, from the glass softening temperature to 50° C. above the glass softening temperature, from 10° C. above to 50° C. above the glass softening temperature, from 20° C. above to 50° C. above the glass softening temperature, from 30° C. above to 50° C. above the glass softening temperature, or even from 40° C. above to 50° C. above the glass softening temperature. The time t may also be within the range of from 10 to 1000 seconds, 15 to 1000 seconds, 20 to 1000 seconds, 30 to 1000 seconds, 40 to 1000 seconds, 50 to 1000 seconds, 60 to 1000 seconds, 75 to 1000 seconds, 100 to 1000 seconds, 125 to 1000 seconds, 150 to 1000 seconds, 175 to 1000 seconds, or even 200 (or more) to 1000 seconds.

Specifically as shown in step 20c, while holding the glass sheet between the first and second gas bearings, the glass sheet is maintained at a viscosity η for a time t such that the value of the expression (t·30 MPa/η) is within the range of from 10 to 10⁶. This expression may also be within the range of from 15 to 10⁶, from 20 to 10⁶, 30 to 10⁶, 50 to 10⁶, 10² to 10⁶, 10³ to 10⁶, 10³ to 10⁶, 10⁴ to 10⁶, or even 10⁵ to 10⁶.

Specifically as shown in step 20d, while holding the glass sheet between the first and second gas bearings, maintaining the glass sheet at a viscosity η(t) for a time t such that the value of the expression

$$30 MPa \cdot {\int }_{0}^{t} \frac{t}{η ( t )} dt$$

is within the range of from 10 to 10⁶. This expression may also be within the range of from 15 to 10⁶, from 20 to 10⁶, 30 to 10⁶, 50 to 10⁶, 10² to 10⁶, 10³ to 10⁶, 10³ to 10⁶, 10⁴ to 10⁶, or even 10⁵ to 10⁶.

Following the steps shown in FIG. 1, a slow cooling process or a fast cooling process may be used. A slow cooling process is used if a relatively low-stress sheet is desired. A slow fast process is used if a relatively higher-stress sheet is desired, such that some thermal strengthening effects are produced (i.e., in the form of a thermally induced surface compression at the surface of the glass sheet).

If a relatively slow cooling process is to be used, then, after the step of maintaining (step 20 of FIG. 1), the sheet is cooled to ambient temperature over a time period in the range of from 1 minute to 10 hours. This time period be also be in the range of from 2 minutes to 10 hours, 3 minutes to 10 hours, 4 minutes to 10 hours, 5 minutes to 10 hours, 10 minutes to 10 hours, 20 minutes to 10 hours, 30 minutes to 10 hours, 1. to 10 hours, 2 to 10 hours, 3 to 10 hours, 4 to 10 hours, or even 5 (or more) to 10 (or more) hours. This step of cooling may be performed while holding the glass sheet between the first and second gas bearings or while holding the glass sheet between third and fourth gas bearings, or alternatively, by other means.

If a relatively fast cooling process is to be used, then, after the step of maintaining (step 20 of FIG. 1), the sheet is cooled using an effective heat transfer coefficient in the range from 300 W/m²K to 15000 W/m²K. The effective heat transfer coefficient may also be within the range of from 400 W/m²K to 15000 W/m²K, 500 W/m²K to 15000 W/m²K, 600 W/m²K to 15000 W/m²K, 700 W/m²K to 15000 W/m²K, 800 W/m²K to 15000 W/m²K, 900 W/m²K to 15000 W/m²K, 1000 W/m²K to 15000 W/m²K, 1250 W/m²K to 15000 W/m²K, 1500 W/m²K to 15000 W/m²K, 1750 W/m²K to 15000 W/m²K, 2000 W/m²K to 15000 W/m²K, 2250 W/m²K to 15000 W/m²K, 2500 W/m²K to 15000 W/m²K, 2750 W/m²K to 15000 W/m²K, 3000 W/m²K to 15000 W/m²K, 400 W/m²K to 15000 W/m²K, 3250 W/m²K to 15000 W/m²K, 3500 W/m²K to 15000 W/m²K, or even 4000 (or more) W/m²K to 15000 W/m²K. This step of cooling may be performed while holding the glass sheet between third and fourth gas bearings or, alternatively, by other means.

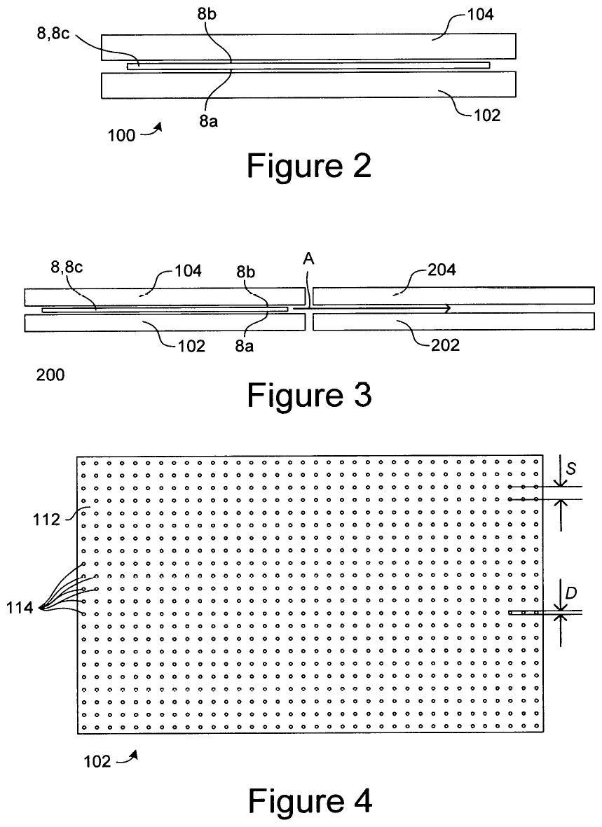

FIG. 2 is a schematic cross-sectional view of an embodiment of an apparatus 100 useful in carrying out methods in accordance with embodiments of the disclosure; FIG. 3 is a schematic cross-sectional view of an embodiment of an apparatus 200 useful in carrying out methods in accordance with embodiments of the disclosure; and FIG. 4 is a plan view of an embodiment of a gas bearing 102 useful in carrying out methods in accordance with embodiments of the disclosure.

The apparatus 100 of FIG. 2 comprises a first gas bearing 102 and a second gas bearing 104 arranged on opposite sides of a glass sheet 8. The glass sheet 8 has first and second major surfaces 8a, 8b on opposite sides thereof and an edge surface 8c surrounding the sheet 8 and connecting the first and second major surfaces 8a, 8b. The sheet 8 is held between the first and second gas bearings 102, 104, with the first major surface 8a adjacent to the first gas bearing 102 and the second major surface 8b adjacent to the second gas bearing 104. In this configuration, the apparatus 100 allows the sheet 8 to be maintained for a relatively long time at a relatively high temperature (or low viscosity) without deformation of the sheet causing lack of flatness (excessive deviation from flatness as over multiple centimeters across the sheet) on the first or second major surface or the sheet, or lack of smoothness (excessive nanometer or micrometer scale roughness) on the first or second major surface of the sheet.

The apparatus 200 of FIG. 3 has the same features as the apparatus 100 of FIG. 2, but further includes a third gas bearing 202 and a fourth gas bearing 204. The third and fourth gas bearing may be used for cooling the sheet 8, particularly in case of cooling the sheet 8 relatively quickly, such as by having or maintaining the third and fourth gas bearings at ambient temperature or at any other relatively low temperature and moving the sheet from the first and second gas bearings 102, 104, to the third and fourth gas bearings 202, 204 in the direction indicated by the arrow A.

FIG. 4 depicts a plan view of the first gas bearing 102, but the second gas bearing 104 is desirably similar or identical to the first gas bearing 102. As shown in FIG. 4, the first gas bearing 102 comprises a bearing surface 112 having holes 114 therein for gas passage therethrough. The holes desirably have an average center-to-center spacing S in the range of from 20 micrometers to 1 centimeter. The average center-to-center spacing may also be in the range of from 20 micrometers to 5 mm, 20 micrometers to 3 mm, 20 micrometers to 2 mm, 20 micrometers to 1 mm, 20 to 800 micrometers, 20 to 600 micrometers, 20 to 500 micrometers, 20 to 400 micrometers, 20 to 300 micrometers, 20 to 200 micrometers, or even 20 to 100 (or even less) micrometers. Holes 114 further desirably have an average diameter D in the range of from 5 micrometers to 1 millimeter. The average diameter may also be in the range of from 5 to 5 to 500 micrometers, 5 to 200 micrometers, 5 to 150 micrometers, 5 to 100 micrometers, 5 to 75 micrometers, 5 to 50 micrometers, 5 to 40 micrometers, 5 to 30 micrometers, 5 to 25 micrometers, 5 to 20 micrometers, 5 to 15 micrometers, or even 5 to 10 micrometers.

### Experiment 1

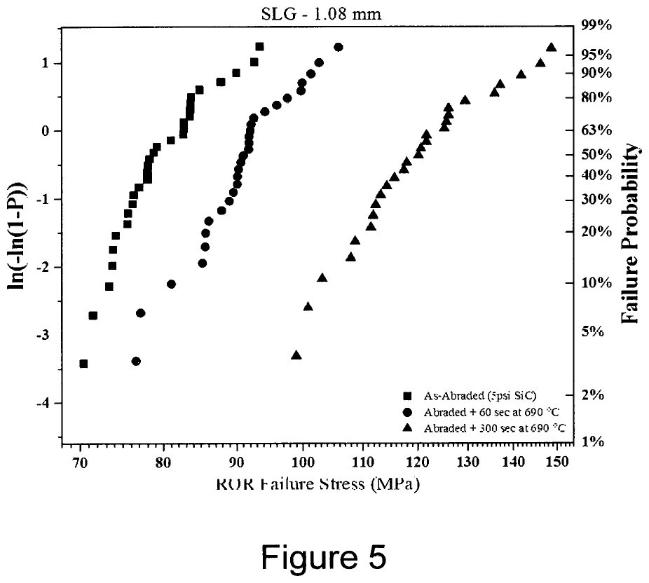

Samples of 2.54×2.54 cm 1.08 mm thick soda-lime glass were abraded, in the center of one major surface, using SiC particles. A total of 90 abraded samples were divided into three equal sets of 30 each: (1) no treatment according to the present disclosure; (2) held at 690° C. for 60 seconds before fast cooling (quenching); (3) held at 690° C. for 300 seconds before fast cooling. To equalize stresses and remove the strengthening effects of thermal stresses in the fast-cooled samples, all three sets were then annealed at 550° C. for two hours followed by gradual cooling in the annealing furnace so as to remove stresses and establish same fictive temperature for each set. All three sets were then tested using the ring-on-ring method. Results are shown in FIG. 5, illustrating that the process of the present disclosure can produce significant strengthening even of abraded glass sheets, apart from or in addition to strengthening due to thermally induced surface compression of the sheet.

### Experiment 2

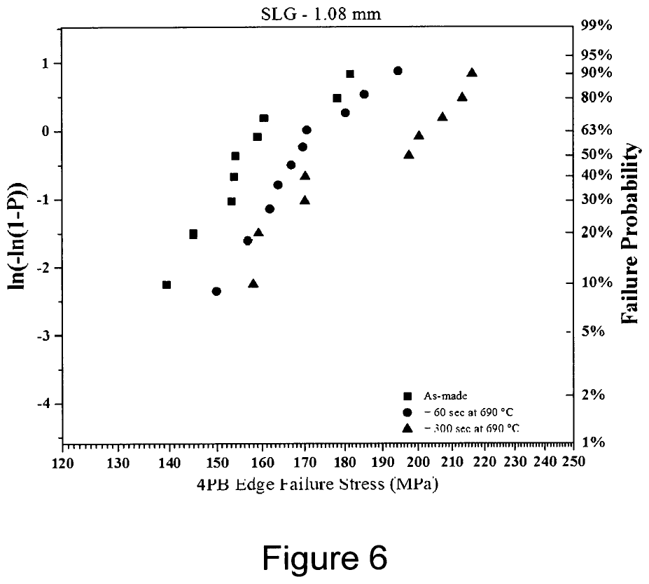

Samples of 114×61 mm 1.08 mm thick glass were prepared with ground edges (400 grit). Again a total of 90 samples were abraded then divided into three equal sets of 30 each: (1) no treatment according to the present disclosure; (2) held at 690° C. for 60 seconds before fast cooling (quenching); (3) held at 690° C. for 300 seconds before fast cooling. To equalize stresses and remove the strengthening effects of thermal stresses in the fast-cooled samples, all three sets were then annealed at 550° C. for two hours followed by gradual cooling in the annealing furnace so as to remove stresses and establish same fictive temperature for each set. All three sets were then tested using four-point bending. Results are shown in FIG. 6, illustrating that the process of the present disclosure can produce significant edge strengthening even apart from or in addition to any edge strengthening due to thermally induced surface compression of the sheet.

### Experiment 3

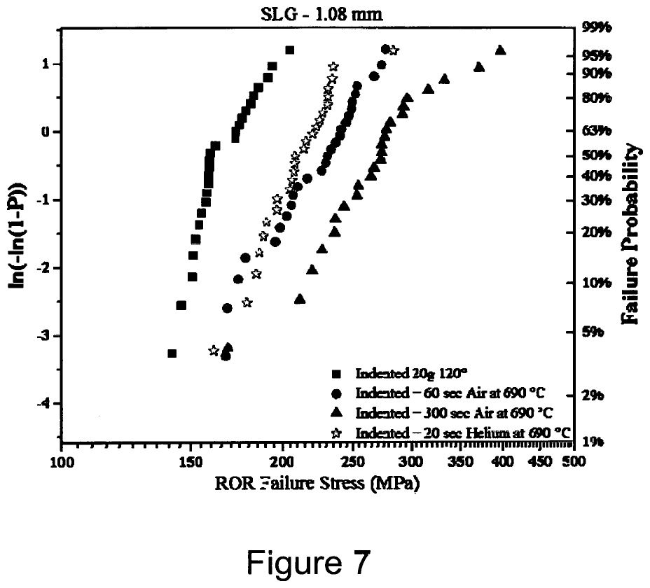

Samples of 2.54×2.54 cm 1.08 mm thick soda-lime glass were indented in the center of one major surface with a Vickers tip. A total of 90 samples were indented then divided into three equal sets of 30 each: (1) no treatment according to the present disclosure; (2) held at 690° C. for 60 seconds before fast cooling (quenching); (3) held at 690° C. for 300 seconds before fast cooling. To equalize stresses and remove the strengthening effects of thermal stresses in the fast-cooled samples, all three sets were then annealed at 550° C. for two hours followed by gradual cooling in the annealing furnace so as to remove stresses and establish same fictive temperature for each set. All three sets were then ring-on-ring tested. Results are shown in FIG. 7, illustrating that the process of the present disclosure can produce significant strengthening even of indented glass sheets, apart from or in addition to any edge strengthening due to thermally induced surface compression of the sheet.

It will be appreciated that the various disclosed embodiments can involve particular features, elements or steps that are described in connection with that particular embodiment. It will also be appreciated that a particular feature, element or step, although described in relation to one particular embodiment, can be interchanged or combined with alternate embodiments in various non-illustrated combinations or permutations.

It is to be understood that, as used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Ranges can be expressed herein as from “about” one particular value, and/or to “about” another particular value. When such a range is expressed, embodiments include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments can be disclosed using the transitional phrase “comprising,” it is to be understood that alternative embodiments, including those that can be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C.

It will be apparent to those skilled in the art that various modifications and variations can be made to the present disclosure without departing from the spirit and scope of the disclosure. Thus, it is intended that the present disclosure cover the modifications and variations of this disclosure provided they come within the scope of the appended claims and their equivalents.

1. A method of thermally treating a glass sheet, the method comprising:
holding a glass sheet between first and second gas bearings, the glass sheet having first and second major surfaces on opposite sides thereof and an edge surface surrounding the sheet and connecting the first and second major surfaces, the glass sheet being held with the first major surface adjacent to the first gas bearing and the second major surface adjacent to the second gas bearing, a glass of the glass sheet having a glass transition temperature; and
while holding the glass sheet between the first and second gas bearings, maintaining the glass sheet at a temperature T, where T is a temperature in the range of from 50° to 250° C. above the glass transition temperature, for a time t within the range of 5 to 1000 seconds.

2. A method of thermally treating a glass sheet, the method comprising:
holding a glass sheet between first and second gas bearings, the glass sheet having first and second major surfaces on opposite sides thereof and an edge surface surrounding the sheet and connecting the first and second major surfaces, the glass sheet being held with the first major surface adjacent to the first gas bearing and the second major surface adjacent to the second gas bearing, a glass of the glass sheet having a glass softening point temperature; and
while holding the glass sheet between the first and second gas bearings, maintaining the glass sheet at a temperature T, where T is a temperature within the range of 100° C. below to 50° C. above the glass softening temperature, for a time t within the range of 5 to 1000 seconds.

3. A method of thermally treating a glass sheet, the method comprising:
holding a glass sheet between first and second gas bearings, the glass sheet having first and second major surfaces on opposite sides thereof and an edge surface surrounding the sheet and connecting the first and second major surfaces, the glass sheet being held with the first major surface adjacent to the first gas bearing and the second major surface adjacent to the second gas bearing; and
while holding the glass sheet between the first and second gas bearings, maintaining the glass sheet at a viscosity η for a time t such that the value of the expression
t·COMPα/η
is within the range of from 10 to 10⁶.

4. A method of thermally treating a glass sheet, the method comprising:
holding a glass sheet between first and second gas bearings, the glass sheet having first and second major surfaces on opposite sides thereof and an edge surface surrounding the sheet and connecting the first and second major surfaces, the glass sheet being held with the first major surface adjacent to the first gas bearing and the second major surface adjacent to the second gas bearing; and
while holding the glass sheet between the first and second gas bearings, maintaining the glass sheet at a viscosity η(t) for a time t such that the value of the expression
$$30 MPa \cdot \text{?} \frac{t}{η ( t )} dt$$
$$\text{?} \text{indicates text missing or illegible when filed}$$
is within the range of from 10 to 10⁶.

5. The method according to claim 1, further comprising, after the step of maintaining, cooling the sheet to ambient temperature over a time period in the range of from 1 minute to 10 hours.

6. The method according to claim 5, wherein the step of cooling is performed while holding the glass sheet between the first and second gas bearings.

7. The method according to claim 1, further comprising, after the step of maintaining, cooling the sheet using an effective heat transfer coefficient in the range from 300 W/m²K to 15000 W/m²K.

8. The method according to claim 7, wherein the step of cooling is performed while holding the glass sheet between third and fourth gas bearings.

9. The method according to claim 1 wherein the first and second gas bearings each respectively comprise a bearing surface having holes therein for gas passage therethrough, and the holes having an average center-to-center spacing in the range of from 20 micrometers to 1 centimeter.

10. The method according to claim 1 wherein the first and second gas bearings each respectively comprise a bearing surface having holes therein for gas passage therethrough, and the holes having an average diameter in the range of from 5 micrometers to 1 millimeter.
